(19) United States
(12) Patent Application Publication
(10) Pub. No.: US 2021/0016963 A1
(43) Pub. Date: Jan. 21, 2021

(54) Trash can and trash bag combination

(71) Applicant: Po-Hui Lin, Taipei (TW)

(72) Inventor: Po-Hui Lin, Taipei (TW)

(21) Appl. No.: 17/063,760

(22) Filed: Oct. 6, 2020

(51) Int. Cl. B65F 1/06; B65F 1/16

(52) U.S. Cl. CPC B65F 1/06; B65F 1/16

(57) ABSTRACT

A trash can and trash bag combination includes a parallelepiped shell including three clipping members on front and rear ends and a first side of an open top respectively, each clipping member having an adhesive double sided tape on an inner surface; and a positioning member on a second side, the positioning member having an upright member; a lid removably disposed on the shell; and a trash bag including a closed strap around a mouth thereof, the strap having a portion extending out of the trash bag to put on the upright member. The trash bag is securely lined within the shell using the adhesive double sided tapes. In another embodiment, the clipping members are iron and the adhesive double sided tapes are replaced by magnetic members.

### BACKGROUND OF THE INVENTION

### 1. Field of the Invention

The invention relates to trash cans and more particularly to a trash can and trash bag combination in which the trash bag has a closed strap on a top and the strap can be pulled to close the full trash bag for sealing sanitary napkins collected in the trash bag.

### 2. Description of Related Art

A sanitary napkin is an absorbent item worn in the underwear when menstruating, bleeding after giving birth, recovering from gynecologic surgery, experiencing a miscarriage or abortion, or in any other situation where it is necessary to absorb a flow of blood from the vagina.

The used sanitary napkin may smell. Typically, a trash bag is used to contain used sanitary napkins for minimizing odor. However, the sealing mechanism of a trash bag lined the inside of a trash can is not sufficient or even not provided. Thus, people around the trash still smell odor.

Thus, the need for improvement still exists.

### SUMMARY OF THE INVENTION

It is therefore one object of the invention to provide a trash can and trash bag combination comprising a parallelepiped shell including three clipping members on front and rear ends and a first side of an open top respectively, each clipping member having an adhesive double sided tape on an inner surface; and a positioning member on a second side, the positioning member having an upright member; a lid removably disposed on the shell; and a trash bag including a closed strap around a mouth thereof, the strap having a portion extending out of the trash bag to put on the upright member. The trash bag is securely lined within the shell using the adhesive double sided tapes.

The above and other objects, features and advantages of the invention will become apparent from the following detailed description taken with the accompanying drawings.

### BRIEF DESCRIPTION OF THE DRAWINGS

FIG. 1 is a perspective view of a trash can and trash bag combination for sanitary napkins according to the invention;

FIG. 2 is a perspective view of a trash can and trash bag combination for sanitary napkins according to a first preferred embodiment of the invention showing the trash can in an open position by separating the lid from the shell;

FIG. 3 is an enlarged view of an upper portion of the trash can of FIG. 2 showing the trash bag lined the inside of the trash can;

FIG. 4 is a view similar to FIG. 3 showing a closing operation of the trash bag;

FIG. 5 is a perspective view of a trash can and trash bag combination for sanitary napkins according to a second preferred embodiment of the invention showing the trash can in an open position by separating the lid from the shell;

FIG. 6 is an enlarged view of an upper portion of the trash can of FIG. 5 showing the trash bag lined the inside of the trash can; and

FIG. 7 is a view similar to FIG. 6 showing a closing operation of the trash bag.

### DETAILED DESCRIPTION OF THE INVENTION

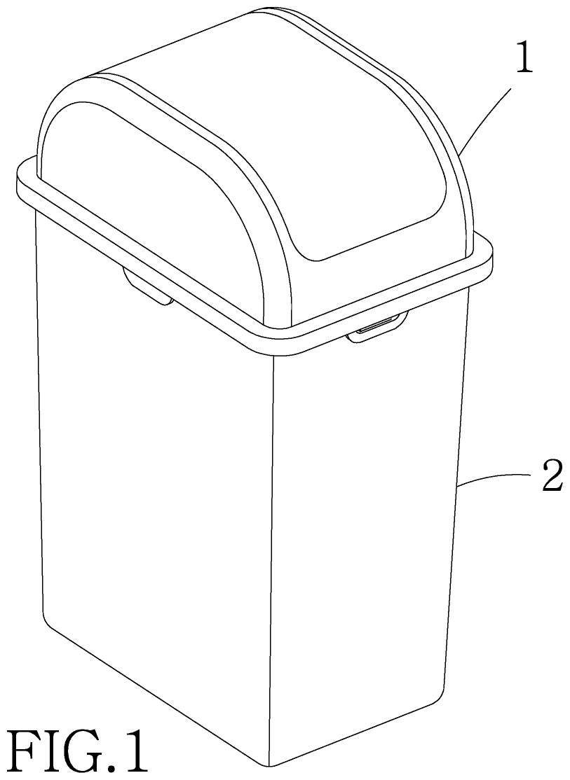

Referring to FIG. 1, a trash can and trash bag combination for sanitary napkins in accordance with the invention comprises a shell 2 and a lid 1 removably disposed on the shell 2.

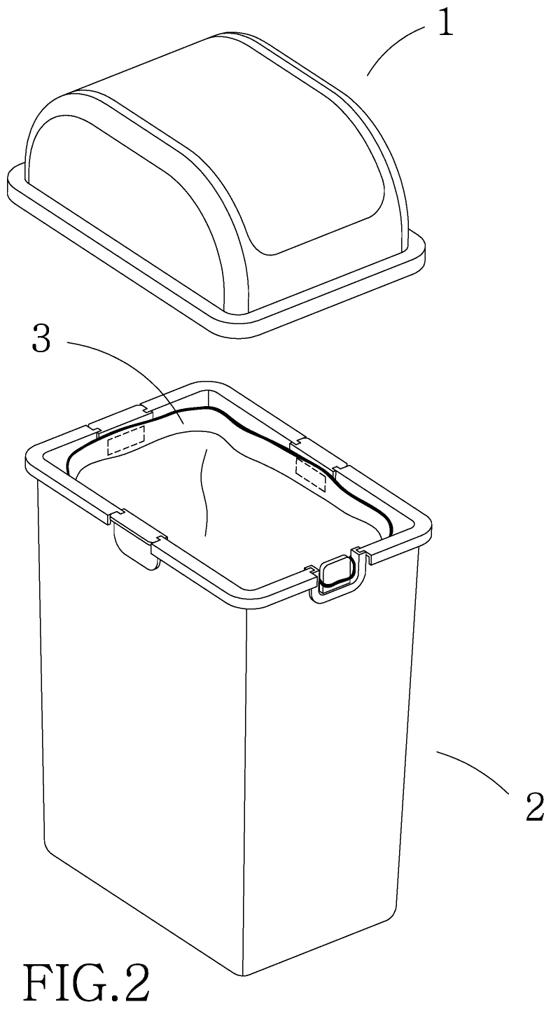

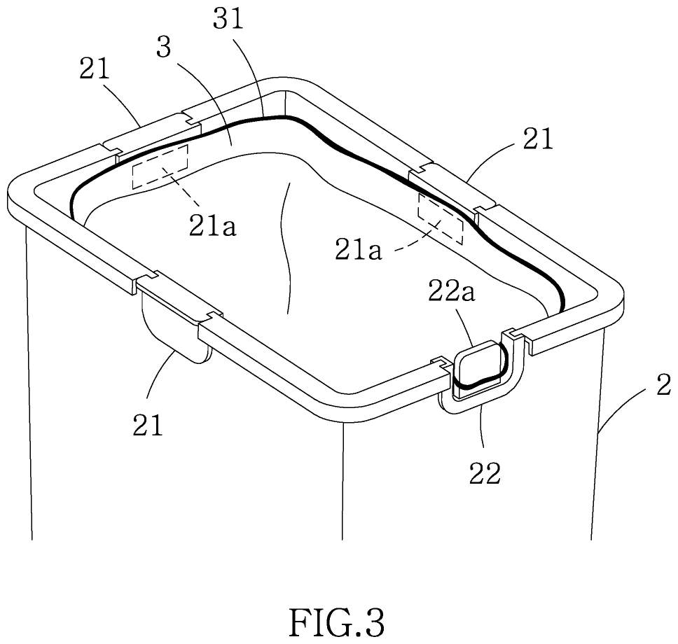

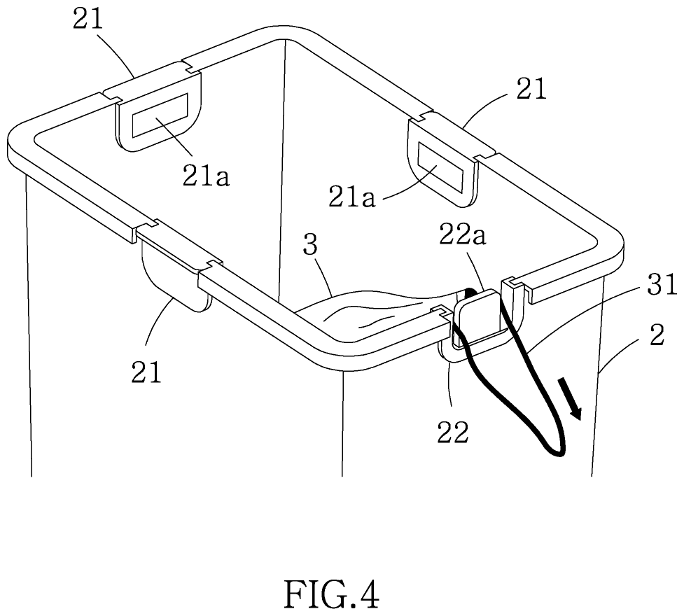

Referring to FIGS. 2 to 4, a trash can and trash bag combination for sanitary napkins in accordance with a first preferred embodiment of the invention comprises a shell 2, a lid 1 removably disposed on the shell 2, and a trash bag 3 as discussed in detail below.

The parallelepiped shell 2 includes three clipping members 21 on front and rear ends and one side of a top respectively, each clipping member 21 having an adhesive double sided tape 21a on an inner surface; and a positioning member 22 on the other side, the positioning member 22 having an upright member 22a.

The trash bag 3 includes a closed strap 31 around a mouth thereof and is securely lined within the shell 2 using the adhesive double sided tapes 21a. A portion of the strap 31 extends out of the trash bag 3 to put on the upright member 22a.

After contents including sanitary napkins in the trash bag 3 is full, an individual may grasp the exposed portion of the strap 31 and pull same to separate the trash bag 3 from the front and rear ends and one side of the shell 2 by disengaging the trash bag 3 from the adhesive double sided tapes 21a until the trash bag 3 is closed at the other side of the shell 2. This has the effect of minimizing odor.

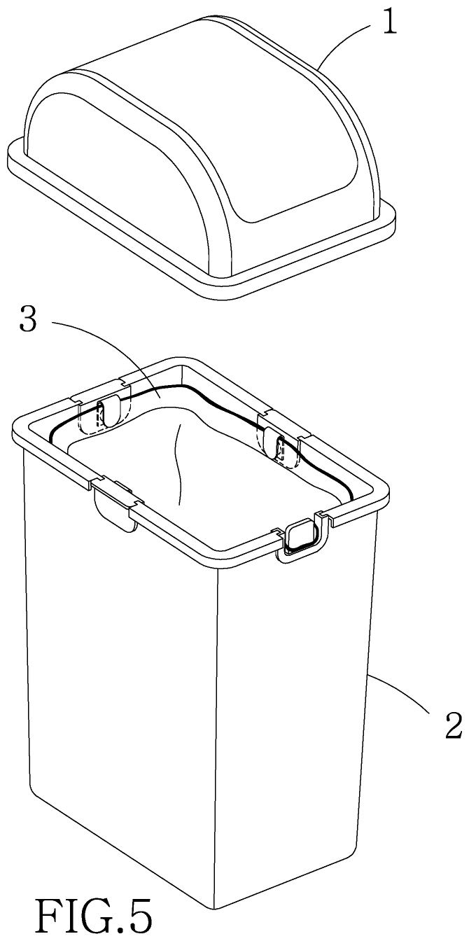

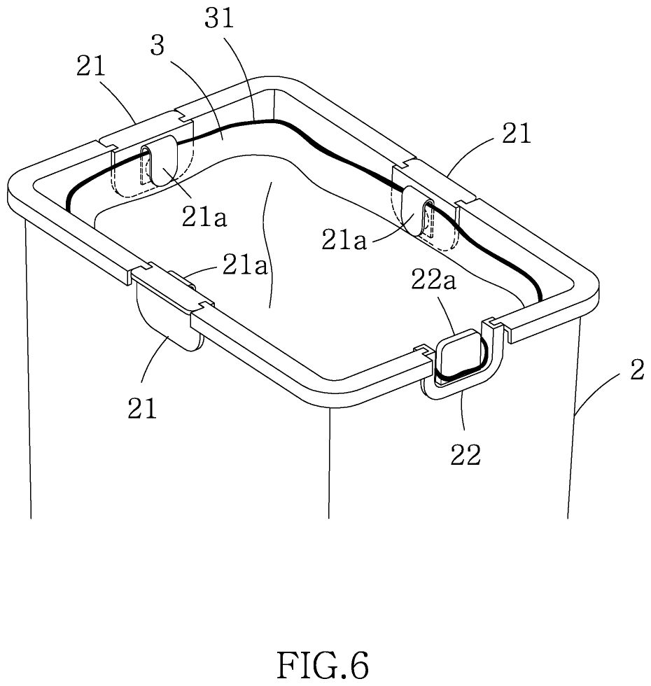

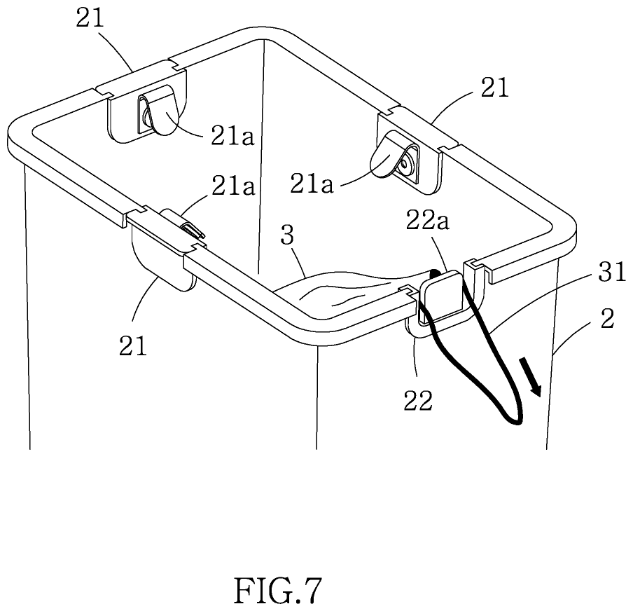

Referring to FIGS. 5 to 7, a trash can and trash bag combination for sanitary napkins in accordance with a second preferred embodiment of the invention comprises a shell 2, a lid 1 removably disposed on the shell 2, and a trash bag 3 as discussed in detail below.

The parallelepiped shell 2 includes three iron clipping members 21 on front and rear ends and one side of a top respectively, each iron clipping member 21 having a spaced magnetic member 21a adjacent to an inner surface; and a positioning member 22 on the other side, the positioning member 22 having an upright member 22a.

The trash bag 3 includes a closed strap 31 around a mouth thereof and is securely lined within the shell 2 because the magnetic member 21a attracts the iron clipping member 21a. A portion of the strap 31 extends out of the trash bag 3 to put on the upright member 22a.

After contents including sanitary napkins in the trash bag 3 is full, an individual may grasp the exposed portion of the strap 31 and pull same to separate the trash bag 3 from the front and rear ends and one side of the shell 2 by disengaging the trash bag 3 from the iron clipping members 21 until the trash bag 3 is closed at the other side of the shell 2. This has the effect of minimizing odor.

While the invention has been described in terms of preferred embodiments, those skilled in the art will recognize that the invention can be practiced with modifications within the spirit and scope of the appended claims.

What is claimed is:

1. A trash can and trash bag combination comprising:
a parallelepiped shell including three clipping members on front and rear ends and a first side of an open top respectively, each clipping member having an adhesive double sided tape on an inner surface; and a positioning member on a second side, the positioning member having an upright member;
a lid removably disposed on the shell; and
a trash bag including a closed strap around a mouth thereof, the trash bag having a portion extending out of the trash bag to put on the upright member;
wherein the trash bag is securely lined within the shell using the adhesive double sided tapes.

2. A trash can and trash bag combination comprising:
a parallelepiped shell including three iron clipping members on front and rear ends and a first side of an open top respectively, each iron clipping member having a spaced magnetic member adjacent to an inner surface; and a positioning member on a second side, the positioning member having an upright member;
a lid removably disposed on the shell; and
a trash bag including a closed strap around a mouth thereof, the strap having a portion extending out of the trash bag to put on the upright member;
wherein the trash bag is securely lined within the shell by attracting the magnetic members to the iron clipping members.
